(19) United States
(12) Patent Application Publication
(10) Pub. No.: US 2016/0019493 A1
(43) Pub. Date: Jan. 21, 2016

(54) OVERNIGHT PRODUCTIVITY DASHBOARD

(71) Applicant: Wal-Mart Stores, Inc., Bentonville, AR (US)

(72) Inventors: Aaron Santavicca, Bentonville, AR (US); James William Burgmeier, Bentonville, AR (US); Jeffrey Scott Cruz, Bentonville, AR (US); Marsha Talmadge David, Rogers, AR (US); John L. Sokolsky, Bentonville, AR (US); Walter King Wilson, IV, Carl Junction, MO (US); Justin Lynn Brandon, Bentonville, AR (US)

(21) Appl. No.: 14/776,211

(22) PCT Filed: Mar. 17, 2014
(86) PCT No.: PCT/US14/30481

§ 371 Date: Sep. 14, 2015

Related U.S. Application Data
(63) Continuation-in-part of application No. 13/918,445, filed on Jun. 14, 2013.
(60) Provisional application No. 61/798,013, filed on Mar. 15, 2013.

(51) Int. Cl. G06Q 10/06

(52) U.S. Cl. CPC G06Q 10/063114; G06Q 10/0633

(57) ABSTRACT

A freight processing system includes a programmable processor, and a memory operatively coupled to the processor. The memory has stored thereon computer-executable instructions that when executed by the processor cause the processor to access a database holding freight data representing each of a plurality of freight units scheduled to be shipped to a receiving site in a single truck load, the database being operatively coupled to the processor, assess the freight data using a set of business rules, assign a priority to each of the freight units based at least in part on the assessment of the freight data, calculate a workload estimate representing an amount of time to be allocated for processing all of the freight units at the receiving site based at least in part on the set of business rules, and generate report data representing: the priority assigned to each respective freight unit, and the workload estimate.

### RELATED APPLICATIONS

This application claims priority to U.S. Provisional Patent Application No. 61/798,013, filed on Mar. 15, 2013, and U.S. patent application Ser. No. 13/918,445, filed on Jun. 14, 2013, the contents of each of which are incorporated by reference herein in their entirety.

### BACKGROUND

Embodiments of the disclosure are related generally to methods and system for managing the receipt of freight, and more particularly to methods and systems for automatically planning for the receiving of freight, automatically generating freight unload plans, and automatically collecting data for quality assurance auditing.

In the retail industry, merchandise is often shipped by truck from distribution centers or warehouses to stores, sometimes on a daily basis or other regular schedule. In some instances, a wide variety of merchandise destined for a particular store can be consolidated into a single load of freight. For example, a single load of freight may include many different items, e.g., housewares, groceries, clothing, electronics, etc., having different sizes, weights and packaging, which upon delivery are to be unloaded from the truck and stocked or warehoused in different locations around the store.

Receiving a consolidated load of freight can be labor intensive and time consuming, as all of the merchandise must be identified and appropriately handled as it is unloaded. Furthermore, the time and/or labor resources needed to receive the freight can vary from load to load, depending on the composition of each load, which may not be known until the freight has been shipped.

### SUMMARY

According to an embodiment, a computer-implemented method of processing freight data includes electronically accessing a database holding freight data representing each of a plurality of freight units scheduled to be shipped to a receiving site in a single truck load, electronically assessing the freight data using a set of business rules, electronically assigning a priority to each of the freight units based the assessment of the freight data, electronically calculating a workload estimate representing an amount of time to be allocated for processing all of the freight units at the receiving site based at least in part on the set of business rules, and electronically generating report data representing: the priority assigned to each respective freight unit, and the workload estimate.

In some embodiments, the method may include assigning the priority based at least in part on a sequence in which the respective freight unit is to be processed at the receiving site, and further calculating the workload estimate based at least in part on the priority. In some embodiments, the method may include calculating the workload estimate based at least in part on an allocation of labor resources to be used for processing the respective freight unit at the receiving site, and further assigning the priority based at least in part on the workload estimate.

In some embodiments, the step of assigning the priority may include assigning the priority based at least in part on a size of the respective freight unit. In some embodiments, the priority assigned to the respective freight unit may be higher than the priority assigned to another freight unit having a smaller size than the respective freight unit. In some embodiments, the workload estimate may be based at least in part on historical data representing amounts of time previously utilized for processing freight units at the receiving site. In some embodiments, the method may include providing an application configured to display at least some of the report data via a user interface.

According to an embodiment, a freight processing system includes a programmable processor, and a memory operatively coupled to the processor. The memory has stored thereon computer-executable instructions that when executed by the processor cause the processor to access a database holding freight data representing each of a plurality of freight units scheduled to be shipped to a receiving site in a single truck load, the database being operatively coupled to the processor, assess the freight data using a set of business rules, assign a priority to each of the freight units based at least in part on the assessment of the freight data, calculate a workload estimate representing an amount of time to be allocated for processing all of the freight units at the receiving site based at least in part on the set of business rules, and generate report data representing: the priority assigned to each respective freight unit, and the workload estimate.

In some embodiments, the priority may correspond to a sequence in which the respective freight unit is to be processed at the receiving site. The workload estimate may be based at least in part on the priority. In some embodiments, the workload estimate may correspond to an allocation of labor resources to be used for processing the respective freight unit at the receiving site. The priority may be based at least in part on the workload estimate.

In some embodiments, the memory may include instructions that when executed by the processor cause the processor to assign the priority based at least in part on a size of the respective freight unit. In some embodiments, the priority assigned to the respective freight unit may be higher than the priority assigned to another freight unit having a smaller size than the respective freight unit. In some embodiments, the workload estimate may be based at least in part on historical data representing amounts of time previously utilized for processing freight units at the receiving site.

In some embodiments, the system may include a user interface operatively coupled to the processor for providing a dashboard application configured to display at least some of the report data via the user interface.

According to an embodiment, a non-transitory computer-readable medium has stored thereon computer-executable instructions that when executed by a computer cause the computer to access a database holding freight data representing each of a plurality of freight units scheduled to be shipped to a receiving site in a single truck load, assess the freight data using a set of business rules, assign a priority to each of the freight units based at least in part on the assessment of the freight data, calculate a workload estimate representing an amount of time to be allocated for processing all of the freight units at the receiving site based at least in part on the set of business rules, and generate report data representing: the priority assigned to each respective freight unit, and the workload estimate.

In some embodiments, the priority may correspond to a sequence in which the respective freight unit is to be processed at the receiving site. The workload estimate may be based at least in part on the priority. In some embodiments, the workload estimate may correspond to an allocation of labor resources to be used for processing the respective freight unit at the receiving site. The priority may be based at least in part on the workload estimate. In some embodiments, the computer-readable medium may include instructions that when executed by the processor cause the processor to assign the priority based at least in part on a size of the respective freight unit. In some embodiments, the priority assigned to the respective freight unit may be higher than the priority assigned to another freight unit having a smaller size than the respective freight unit. In some embodiments, the workload estimate may be based at least in part on historical data representing amounts of time previously utilized for processing freight units at the receiving site.

According to embodiments of the present disclosure a computer-implemented method, system, and computer-readable medium are disclosed for processing freight data, e.g., via a computing device including a processor that is operatively and communicatively coupled to a display. A task can be electronically associated with a freight item to be received by a store via a graphical user interface and an estimated amount of time required to complete the task associated with the freight item can be generated. An available number of workforce hours can be updated based on the estimated amount of time and a workload estimate that accounts for the estimated amount of time can be verified to determine whether the workload estimate is feasible. Report data representing the workload estimate can be generated in response to a determination that the workload estimate is feasible.

In some embodiments, the workload estimate can be verified by determining at least one of whether (i) an available hours for a scheduled sales floor workforce and a scheduled backroom workforce are positive; (ii) the available hours for a scheduled sales floor workforce or a scheduled backroom workforce is negative, but a sum of the available hours is greater than or equal to zero; or (iii) a sum of the available hours for a scheduled sales floor workforce and a scheduled backroom workforce are negative.

Any combination and/or permutation of embodiments is envisioned. Other objects and features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram representing an exemplary load of freight;

FIG. 2 is a block diagram representing an overview of an exemplary computer-implemented process for automatically planning the receiving and unloading of freight in accordance with some embodiments;

FIG. 3 depicts an example of a graphical user interface for displaying report data in accordance with some embodiments;

FIG. 4 is a flow diagram of an example of a computer-implemented process for automatically generating report data in accordance with an embodiment;

FIG. 5 depicts an example of a graphical user interface for displaying freight data in accordance with some embodiments;

FIG. 6 is a block diagram of an example of a freight processing system for carrying out one or more embodiments; and

FIG. 7 is a block diagram of an exemplary client-server freight processing environment for implementing one or more embodiments.

### DETAILED DESCRIPTION

According to various embodiments, computer-implemented methods, non-transitory computer-readable media and electronic commerce systems are disclosed for automatically planning for the receiving of freight at a retail store, automatically generating freight unload action plans, and automatically collecting data for quality assurance auditing. In exemplary embodiments, a web-based graphical user interface can be used for displaying a list of freight items to be unloaded from a truck, the number of labor hours scheduled and available for unloading the freight and performing other activities, and quality auditing information. The planning, unload action plan and/or quality assurance information may be used, for example, by store managers and other employees for identifying freight being delivered to the store before it is unloaded from the truck, and for allocating labor resources for efficiently unloading and handling the freight after it arrives. In general, such information can be used to identify, prior to receiving the freight, what freight items need to be unloaded, how many hours of labor will be necessary to unload the freight, and/or how many people will be assigned to unload the freight after it arrives.

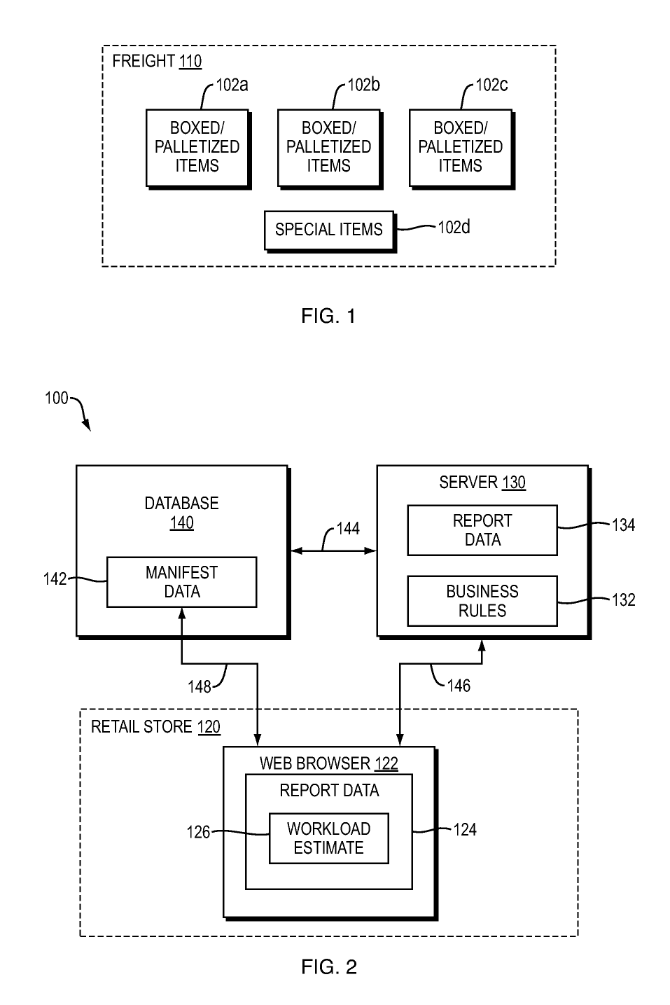

FIG. 1 is a block diagram representing an example of a load of freight 110. The freight 110 includes one or more boxes and/or pallets of items 102a, 102b, 102c, and/or special items 102d (e.g., promotional, sale, and/or limited availability items) of varying sizes, although it will be understood that the freight may be shipped in other configurations, such as loose items or items packed in shipping containers. Individual items, or packages, cases or pallets of items, may be labeled with identifying information, such as information that can be used to identify the items and/or the destination of the items after they are unloaded (e.g., a department number). The freight 110 is shipped to a retail store, e.g., by truck, where it is subsequently received and unloaded.

FIG. 2 is a block diagram representing an exemplary overview of a computer-implemented process 100 for automatically planning the receiving and unloading of the freight 110 of FIG. 1 at a retail store 120, according to an embodiment. A database 140 stores manifest data 142 (also referred to herein as freight data) representing one or more of the items 102a, 102b, 102c, 102d in the load of freight 110. A server 130, a web browser 122 and/or other client application can access the database 140, or another data storage system (not shown), via communications network 144, 146, 148. The server 130 can be configured to apply a set of business rules 132 to the manifest data 142 for generating report data 134. The business rules 132 may include, for example, a set of rules that define how the manifest data 142 is interpreted and presented to a user (e.g., via a computer-implemented user interface) or another computer-implemented process, such as sorting and/or filtering the items 102a, 102b, 102c, 102d in the report data 124 according to various characteristics including: number of items per case, number of cases or pallets, item description, department number, pallet items, non-basic freight items, and/or large cube items.

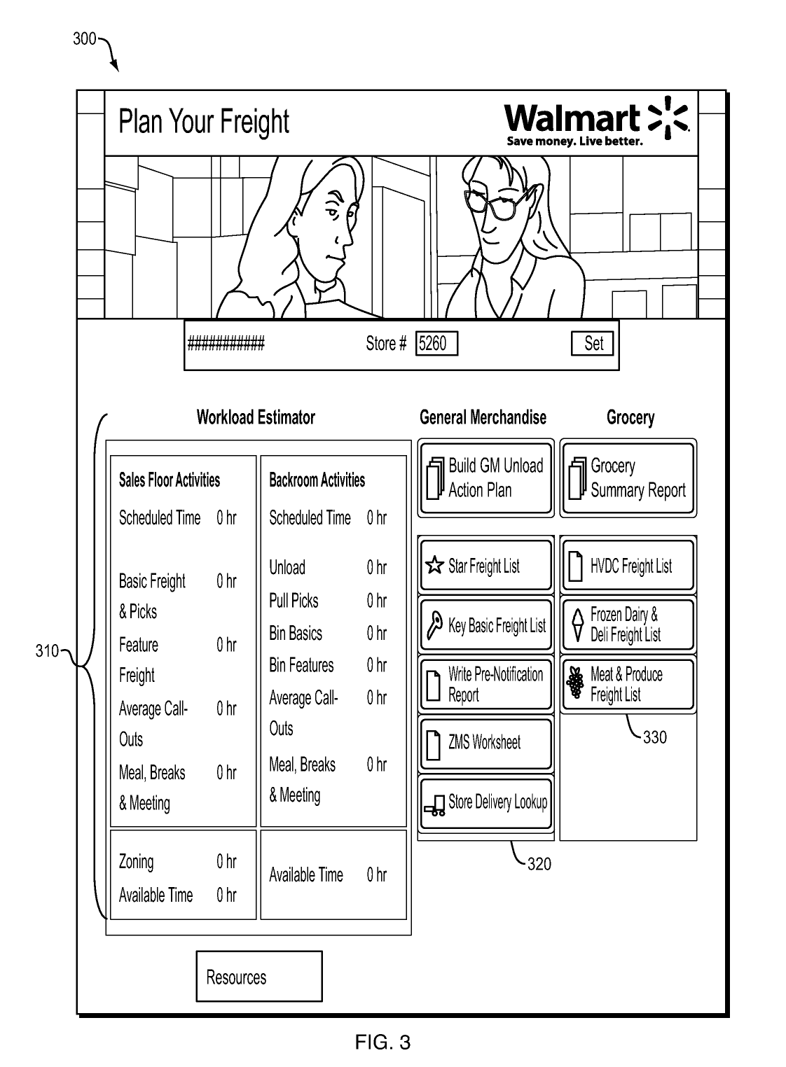

The report data 134 can be transmitted to the web browser 122 via communications network 146. In some embodiments, the web browser 122 executes on a computing device located at the store 120. The manifest data 142 may, in some embodiments, be transmitted via communication network 144, 146, 148 to, and be displayed by, the web browser 122. In some embodiments, the web browser 122 can be configured to generate and display the report data 134 to a user via a graphical user interface, such as the example graphical user interface 300 depicted in FIG. 3.

When the freight 110 is shipped by truck from a distribution center to a retail store, the freight manifest data 142 can be generated, or the freight manifest data 142 can be generated as the truck is being loaded, as the freight is being shipped, or at any other suitable time (e.g., any time prior to unloading the truck). In some embodiments, the freight manifest data 142 is generated by the distribution center or other entity responsible for shipping the freight. The manifest data 142 represents the types and quantities of items 102a, 102b, 102c, 102d in the load. For example, the manifest data 142 may include information indicating that the freight 110 includes thirty-five cases of athletic socks, twenty-four cases of dry dog food, eight cases of apples, etc. The retail store 120 can receive the manifest data 142 in advance of delivery and can use the manifest data 142 to plan for receiving and unloading the freight upon arrival. The items 102a, 102b, 102c, 102d may be shipped, for example, in boxes and/or on pallets that are coded such that the store can identify the freight as it is received and determine how the freight should be processed. For instance, some freight may be immediately taken from the receiving dock onto the floor of the store 120, where the coding indicates the store department or location in which the items are to be stocked. Other freight may be temporarily stored in a backroom, according to the business needs of the store 120, for example, product promotions, sales or specials.

A variety of items can be contained within any given freight load. For example, a truck may be loaded with a mix of furniture, groceries, electronics, clothing, household products, etc. The exact mix may depend, for example, on the present and/or forecast inventory needs of each store, and therefore may vary significantly from load to load. For example, the freight may include a mix of general merchandise or groceries 102a, 102b, 102c for inventory replenishment (e.g., freight that is moved directly into stock upon receipt) and special items 102d for promotional events or special sales (e.g., freight that may be held in a back room or warehouse temporarily before being placed into stock, or freight that may be stocked in a designated location within the store, such as a free-standing display or aisle end-cap shelf).

In some embodiments, the store 120 receives the manifest 142 prior to arrival of the truck. The business rules 132 can be used to determine how each of the items 102a, 102b, 102c are to be processed upon receipt at the store 120. Some or all of the items in the freight 110 can be prioritized based on the business rules 132. For example, large boxes or perishable items may have a higher priority than small boxes or certain non-perishable items. In another example, general merchandise or groceries 102a, 102b, 102c may have a higher priority than special merchandise 102d. The priority information can be transmitted to the store 120 as part of the report data 134 and used by the store for planning purposes. During the receiving process, the store 120 may use the priority information to determine, for example, the order in which the items 102a, 102b, 102c, 102d are to be unloaded from the truck and moved either directly onto the floor or into a backroom for storage. The priority information may also be used to identify exceptions, that is, items that are to be specially handled (e.g., promotional items that are to be stocked in a different location than non-promotional items of the same type). In some embodiments, labels affixed to each unit of freight can be used to visually identify the contents of the freight and correlate such freight with the priority information.

A workload estimate 126 can be automatically calculated based on the items 102a, 102b, 102c, 102d identified in the manifest 142 and the business rules 132 (e.g., the respective priorities assigned to the items). The workload estimate 126 is an estimate of the number of labor hours that are required to unload and receive the freight 110. The workload estimate 126 may, for example, be calculated at least in part on predetermined labor times included in the business rules 132. For example, the predetermined labor time for unloading one case of books may be one minute, and therefore if the freight 110 includes thirty-six cases of books, the workload estimate 126 will be at least thirty-six minutes for unloading that portion of the freight. The workload estimate 126 may, for example, depend at least in part on the size, weight and/or quantity of the items to be unloaded and whether the items 102a, 102b, 102c, 102d are shipped loose, boxed or palletized. For instance, items shipped on pallets may be unloaded by fewer workers and/or in less time than boxed or loose items. Further, heavier or larger items may take more time to unload than lighter or smaller items. The preceding examples are intended to be non-limiting factors that may be used at least in part to calculate the workload estimate 126.

In some embodiments, the workload estimate 126 can be calculated based on one or more of the following non-limiting examples; (1) total scheduled labor hours for a given day; (2) average total call-out labor hours (e.g., unavailable scheduled labor hours); based on historical average (e.g., over the most recent six weeks); (3) total labor break time; (4) available time remaining after accounting for labor call-outs, breaks and/or other scheduled hour reductions; (5) total labor time required to perform various backroom activities; (6) total labor time required to perform various sales floor activities; (7) hours required to complete tasks associated with receiving replenishment freight; and (8) hours required to complete tasks associated with receiving non-replenishment freight (e.g., special freight or large freight).

Various factors used to calculate the workload estimate, some examples of which are listed above, can be based on the set of predetermined business rules 132, the freight manifest data 142, or a combination thereof.

The workload estimate 126 can include the number of labor hours scheduled by the store 120 during the period of time in which the freight 110 is to be unloaded as well as the number of estimated labor hours for performing certain tasks, such as unloading and receiving freight. For example, if the freight is to be unloaded between the hours of 11 PM and 5 AM, and fifty employees are scheduled to work during those six hours, then the number of scheduled hours is 300. If the workload estimate 126 is, for example, 150 hours, then the store 120 can use this information to anticipate that half of the scheduled hours are to be allocated for receiving the freight 110, and may use this information for planning purposes prior to arrival of the freight.

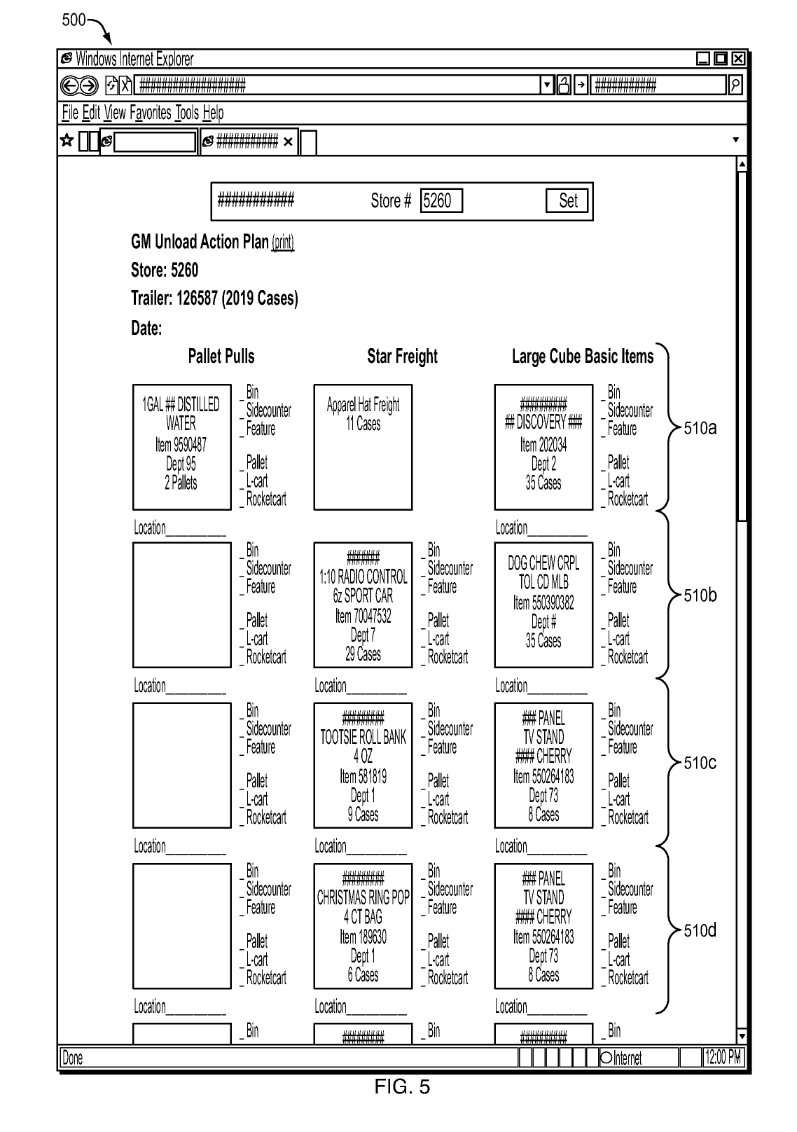

One example of a graphical user interface 300 for displaying a report 310 containing the workload estimate 126 is depicted in FIG. 3. In this example, the workload estimate, as displayed via the user interface 300, may contain the total scheduled labor time and break-downs of the estimated labor time for performing certain activities, such as unloading basic freight (e.g., including items for replenishing stock) and unloading feature freight (e.g., including special items, such as seasonal or limited-quantity goods). Further, the workload estimate 126 may be calculated based on how much of the scheduled time is estimated to be allocated to non-labor activities, such as breaks, meetings and call-outs (e.g., including employees who do not work all or part of their scheduled shifts). The workload estimate 126 may be further divided into different types of activities, such as sales floor activities and backroom activities. In this manner, different workload estimates can be generated for groups of tasks that each share at least some common labor resources. Also depicted in the graphical user interface 300 are buttons for selecting a general merchandise unload action plan 320 and a grocery unload action plan 330 (e.g., unload action plans can be generated for both general merchandise in the freight and groceries in the freight), such as described below with respect to FIG. 5.

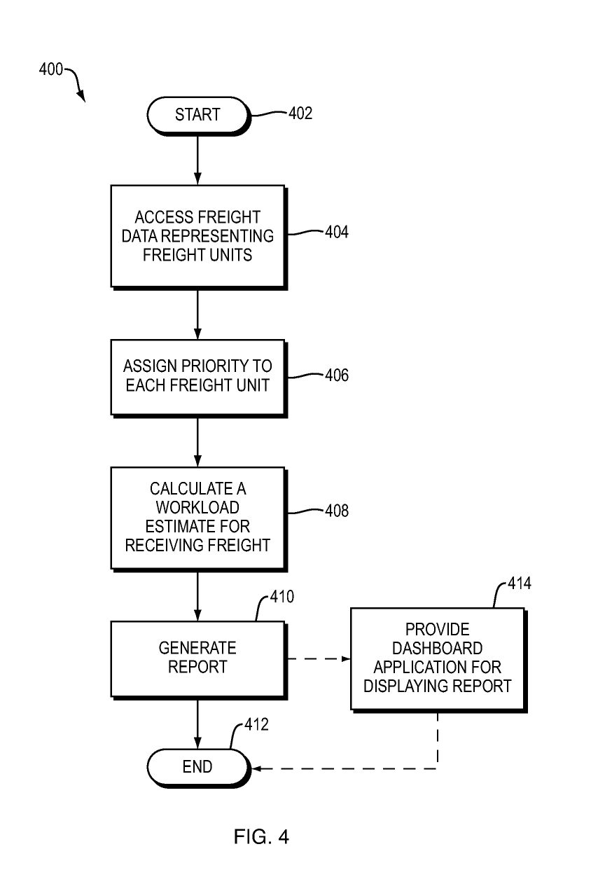

FIG. 4 depicts a flow diagram of an exemplary computer-implemented process 400 for automatically generating report data for use in a graphical user interface, according to an embodiment. Process 400 begins at step 402. At step 404, freight data representing freight units is accessed by a processor. The freight units may represent, for example, individual items, such as items 102a, 102b, 102c, 102d in FIG. 1, boxes of items, and/or pallets of items scheduled to be shipped to a receiving site (e.g., the retail store 120 of FIG. 1). The freight data can include a plurality of processing codes. Each processing code can correspond to one or more of the items 102a, 102b, 102c, 120d included in the freight. At step 406, a priority is assigned to each freight unit based on, for example, the respective processing code and the business rules 132 of FIG. 1. In some embodiments, the priority corresponds to a sequence in which the freight units are to be received, unloaded and/or processed at the receiving site. In some embodiments, the priority corresponds to the size and/or weight of the respective freight units (e.g., larger and/or heavier items may be assigned a higher priority than smaller and/or lighter items).

At step 408, a workload estimate for receiving the freight is calculated based on the processing code for each freight unit, the priority assigned to each freight unit and/or the business rules. The workload estimate may represent, for example, an amount of time (e.g., labor hours) to be allocated for receiving, unloading and/or processing (e.g., identifying, organizing, stocking, etc.) all of the freight units at the receiving site. At step 410, a report is generated by the processor. The report can include report data representing the priority assigned to each freight unit and/or the workload estimate. In some embodiments, the workload estimate can be based on historical data representing amounts of time (e.g., labor hours) previously utilized for receiving, unloading and/or processing the freight at the receiving site. For example, if a particular type of freight has historically needed 20 minutes to unload at the receiving site, the workload estimate may be based at least in part on this historical value. In another example, the workload estimate may be based at least in part on a historical average number of employees who do not work their scheduled shifts (e.g., call-outs), the average amount of time allocated to work breaks and meetings, and/or other appropriate factors. Process 400 ends at step 412.

In some embodiments, at step 414, a dashboard, web page or other graphical user interface is rendered (e.g., via a web browser or other user interface). The dashboard can be configured to display the report. One example of such a dashboard is depicted and described above with respect to FIG. 3.

FIG. 5 depicts one example of a graphical user interface 500 that can be used to implement exemplary embodiments described herein. The user interface 500 can be configured to display freight data, e.g., an unload action plan, including one or more freight units (e.g., loose items, boxed items, palletized items) of freight to be unloaded. The unload action plan can be generated based on at least the freight manifest data 142 and/or the business rules 132, and can include a list of the freight items 102a, 102b, 102c, 102d. For instance, the user interface 500 may be configured to display the list of freight items 102a, 102b, 102c, 102d in a particular order according to the unload action plan such that items toward the beginning of the list are to be unloaded before items toward the end of the list. The unload action plan may be printed as a hard copy for reference by employees who are performing the physical handling of the received freight 110. In this manner, the unload action plan advantageously provides for easily and immediately identifying the contents of the freight 110 and the order in which the freight 110 is to be unloaded from the truck. For example, when the contents of a box or pallet are visually evident until the box or pallet is opened or broken down, a task associated with the box or pallet may require additional time and labor resources. By providing the unload action plan, exemplary embodiments can provide information regarding the content of the box or pallet and can assign priorities to tasks associated with the box or pallet. The unload action plan may also advantageously provide for enabling labor resources to be assigned to unloading particular items of the freight 110, as listed in the unload action plan. The unload action plan may have the further advantage of enabling the labor resources unloading the freight 110 to easily identify where the unloaded items 102a, 102b, 102c, 102d are to be placed in the store after they are unloaded from the truck.

One or more unload action plans can be generated for different types of freight, for example, general merchandise and grocery freight. Within each unload action plan, the freight can be filtered and/or grouped by, for example, type or category. For example, the freight can be filtered based on one or more business rules that may be used to identify key freight and replenishment freight. The user interface 500 may display, for example, a description of each freight unit, the department each item in the freight unit is to be stocked in, an item number (e.g., a stock-keeping unit (SKU) number or a manufacturer item number), and/or a quantity of units in the freight, as indicated at 510a, 510b, 510c and 510d. The user interface 500 can be used by the store 120 to plan for the labor resources needed to unload the freight 110 and/or to identify particular items contained within the freight 110, such as special freight or non-replenishment freight. In some embodiments, the user interface 500 can display a priority associated with one or more of the freight units 510a, 510b, 510c, 510d. The unload action plans, for example, can be used by management personnel to plan activities, scheduling of labor resources, and to identify the contents of the freight 110 without having to visually inspect the freight 110.

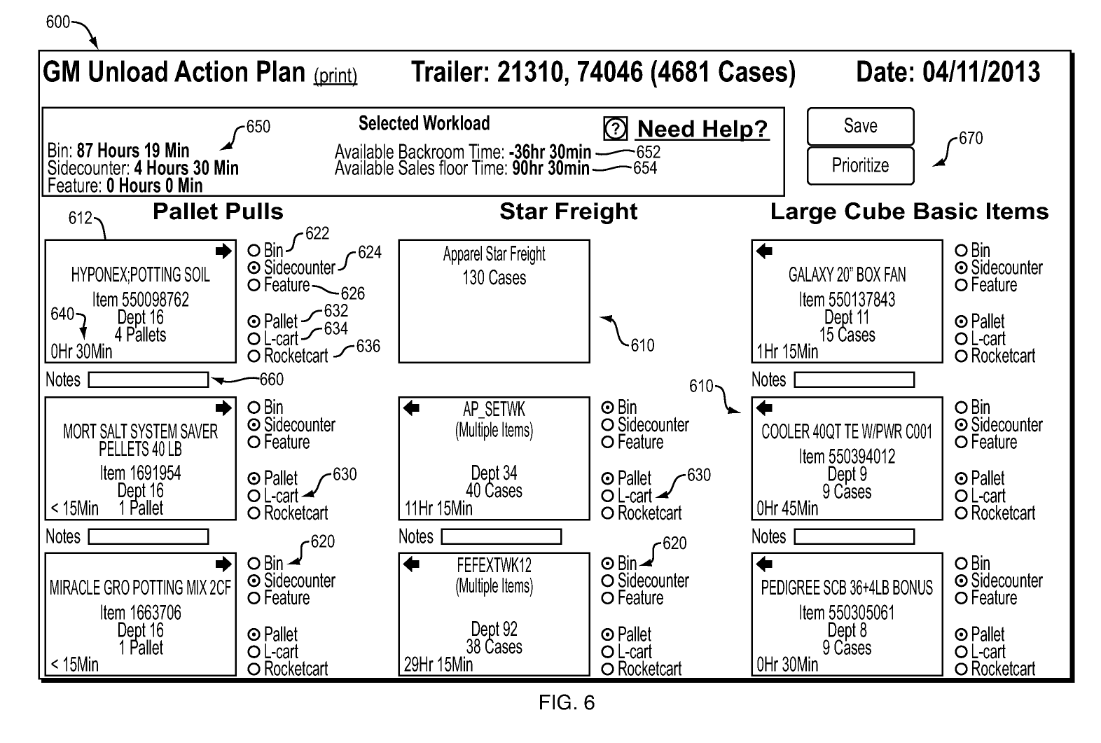

FIG. 6 depicts one example of a graphical user interface 600 that can be used to associate tasks with freight items in accordance with exemplary embodiments described herein. The user interface 600 can be configured to display freight data in a similar manner as the embodiment of the user interface 500 depicted in FIG. 5, except that the user interface 600 can be configured to render an estimated amount of time required to complete a task associated with a freight item. As shown in FIG. 6, the user interface 600 can provide graphical representations 610 (e.g., blocks) of freight items (e.g., items 102a-d) to be received by a store. The graphical representations 610 of the freight items can be organized based on a type of freight begin received (e.g., pallets pulls, star freight, large cube basic items). Information related to the freight items can be included in the graphical representations 610. For example, information included in a graphical representation 612 of a freight item can include product information 614 associated with the item, a department 616 within the store to which the freight item corresponds, and a quantity 618 of the freight item being delivered.

One or more tasks 620 and transportation mechanisms 630 can be associated with the units 610 of freight. In some embodiments, the tasks 620 can be specified programmatically by a processor programmed to execute code to implement one or more processes described herein. In some embodiments, the tasks 620 and transportation mechanism 630 can be specified by a user interacting with the graphical user interface 600 (e.g., via a keyboard, mouse, touch screen). Some examples of tasks 620 that can be associated with a freight item include a bin stocking task 622, a side counter task 624, and a feature stocking task 626. Some examples of transportation mechanisms 630 can include a pallet truck 632, a L-cart 634, or a rocket-cart 636. The user can associate one of the tasks 622-626 and one or more transportation mechanisms 632-636 with the graphical representations 610 corresponding to freight items to identify the tasks 620 and transportation mechanisms 630 to be performed on the freight when the freight is received by the store.

In response to the association of a task 620 to a freight item, a processor executing code to implement one or more processes described herein can determine an estimated amounts of time necessary to complete the tasks 620 associated with the freight items. In some embodiments, the amount of time can be determined based on historical or other data, as described herein. The tasks 620 that can be selected for a given freight item can have different estimated amounts of time required to complete the respective task. For example, a task of feature stocking can take longer than a task of bin stocking. After the processor determines estimated amounts of time required to complete the tasks associated with the freight items, the processor can render the estimated amounts of time 640 with the graphical representations 610 of the freight items.

The processor can be programmed to determine a cumulative amount of time 650 each type of task can take for the freight items, collectively (e.g., a number of hours by area, such as bin stocking, side counter stocking, and feature stocking), and can determine a total number backroom hours available 652 as well as a total number of sales floor hours 654 that are available for completing the tasks associated with the freight (e.g., a selected workload by task type and workforce type). The graphical user interface 600 can include data entry fields 660, e.g., a text boxes, in which text can be entered and associated with the freight units 610 to provide notes, such as, for example, instructions for unloading and/or stocking the freight once it is received by the store. After the tasks 620 and transportation mechanisms 630 have been associated with the units of freight, the user can select a “prioritize” button 670 to instruct the processor to navigate to a prioritization graphical user interface to implement a prioritization process.

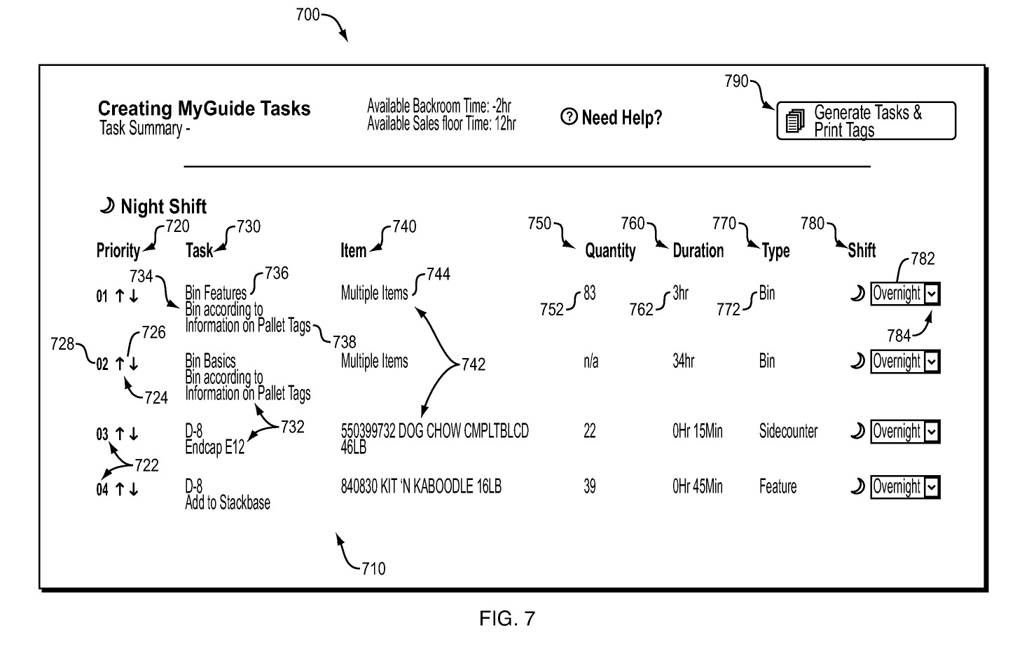

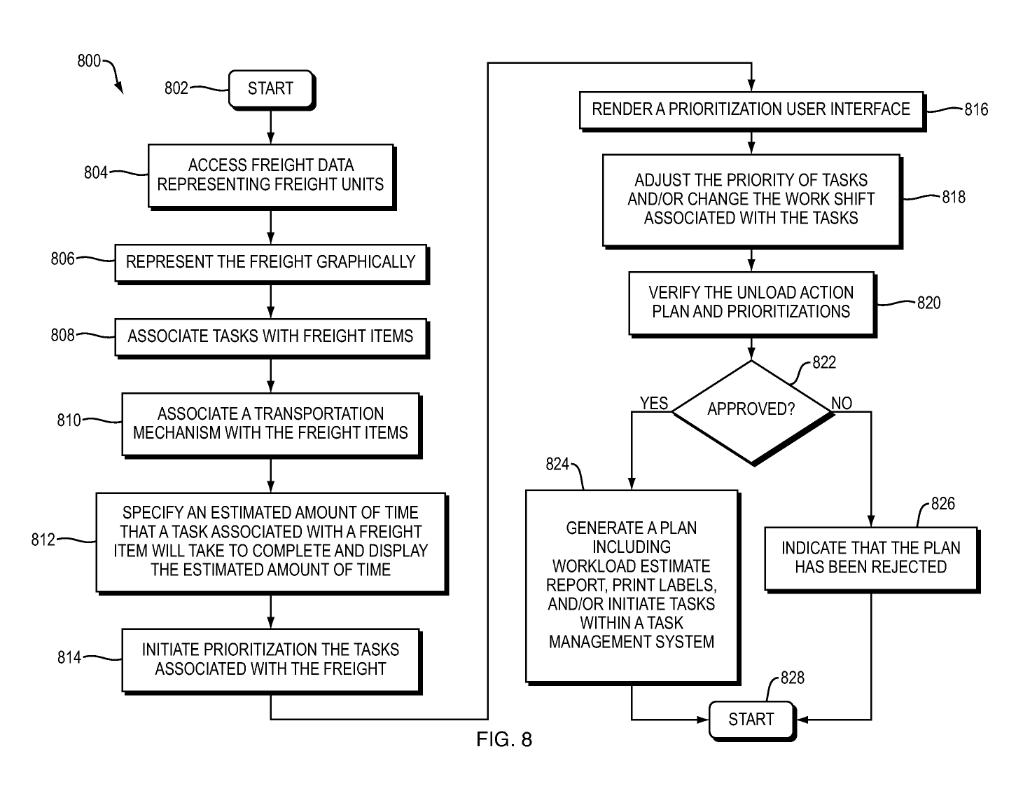

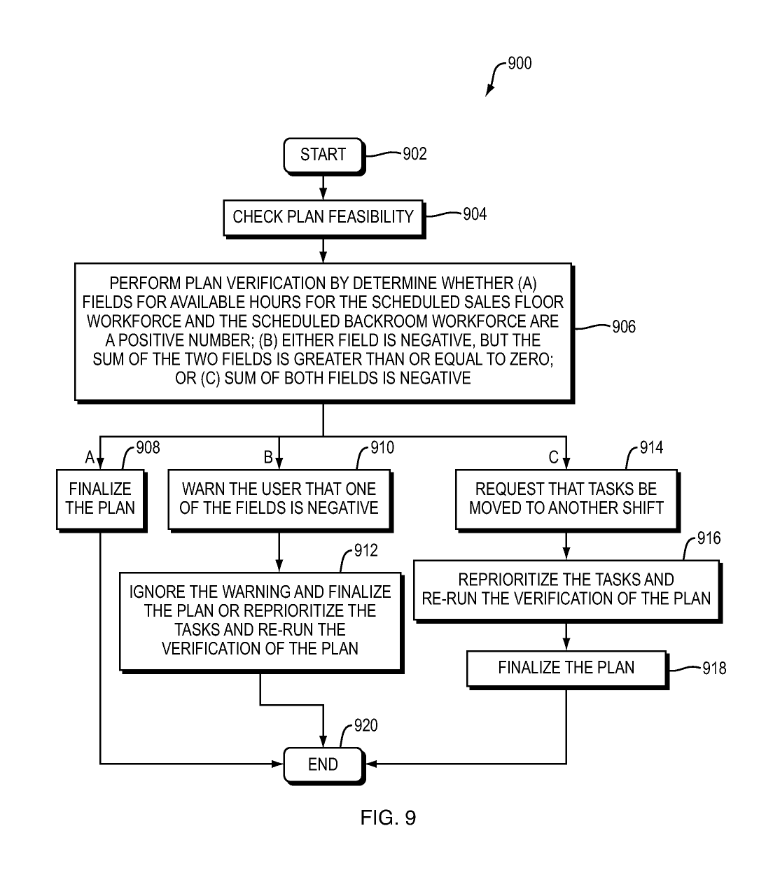

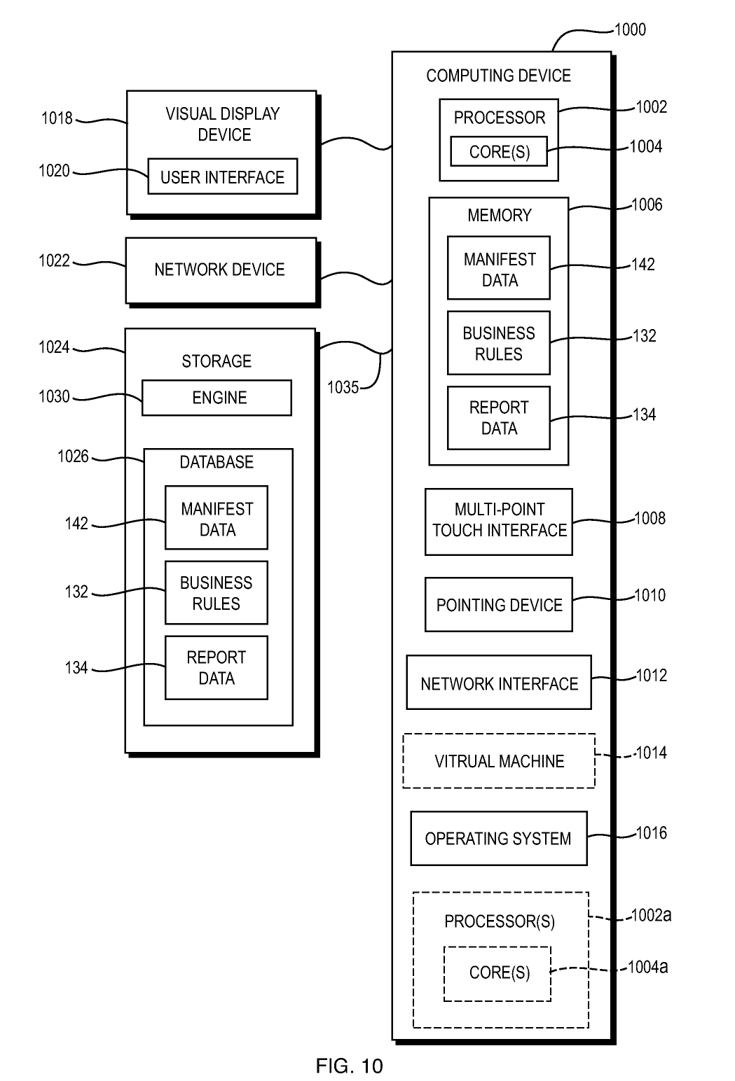

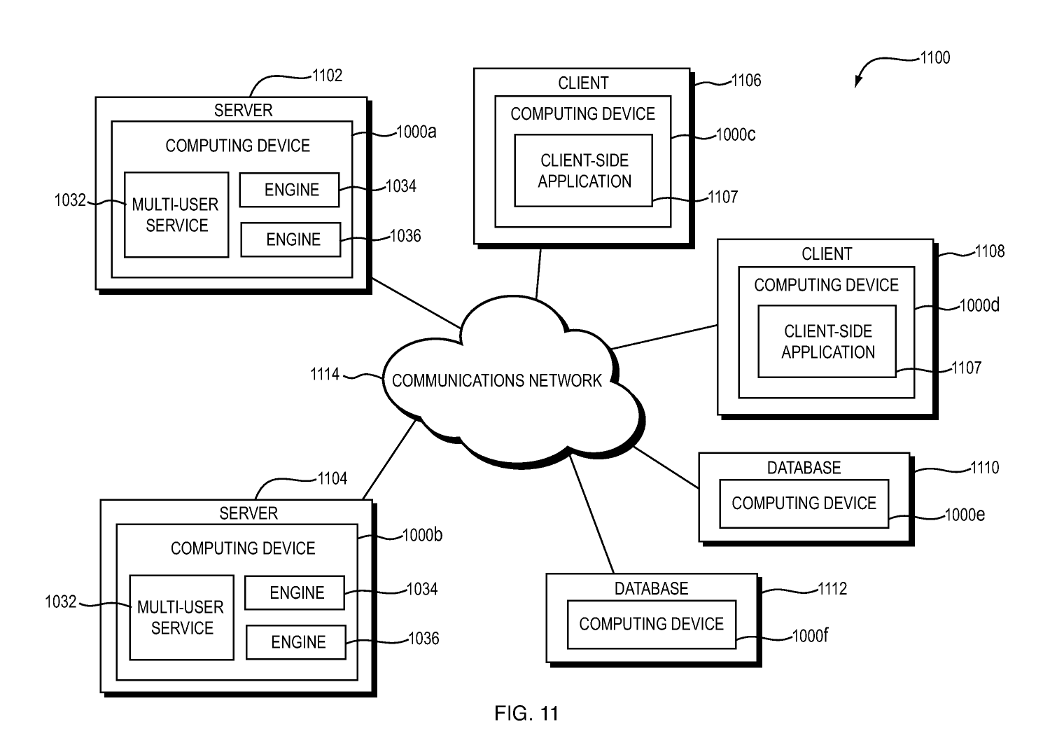

FIG. 7 depicts a one example of a graphical user interface 700 that can be used to prioritize tasks associated with blocks of freight in accordance with exemplary embodiments described herein. In exemplary embodiments, the graphical user interface 700 can be rendered on a display of a computing device in response to a selection of the prioritization button 670 in the graphical user interface 600 shown in FIG. 6. As shown in FIG. 7, the graphical user interface 700 can include a prioritized list 710 of tasks 732 specified by the user in the graphical user interface 600 to be completed during the night shift. The list 710 can include a priority column 720, a task column 730, an item or product column 740, a quantity column 750, a duration column 760, a type column 770, and a shift column 780. The prioritization column 720 can include priorities 722 assigned respective tasks 732. The tasks column 730 can include the tasks 732 to be completed upon receipt of the freight. As shown in FIG. 7, the tasks 732 can be identified by a description 736 of the task and any notes or instructions 738 associated with the tasks 732. The items column 740 can identify the type 742 of items for which the tasks 732 are being performed. For example, a task 734 to can include different types of items, as indicated by the “Multiple Items” entry 744 in the list 710 for the tasks 734. The quantity column 750 can indicate quantities 752 of items included in the freight by task type. The duration column 760 can indicate a total estimated amount of time 762 required to complete the respective tasks in the list 710. The type column 770 can specify the generic task types 772 associated with the tasks 732.

As described herein, the prioritization column 720 can include priorities 722 assigned respective tasks 732 and can include user-selectable elements 724 associated with each priority 722, which are shown as directional arrows pointing up and down in graphical user interface 700. The user can select the elements 724 to adjust the priority of the tasks included in the list 710. For example, the user can select an arrow 726 pointing upwards that is associated with tasks 734, which has the second highest priority of the tasks 732 in the list 710 and the processor can execute code to increase the priority 728 of the tasks 734, which can be illustrated graphical in the in the graphical user interface 700 by moving the tasks 734 and information associated therewith (e.g., item, quantity, duration, type, shift) to the top of the list 710. Likewise, the user can select a downward facing arrow to decrease the priority of a task in the list 710.

As described herein, the shift column 780 identifies shifts 782 (e.g., overnight, daytime) during which the associated tasks 732 are to be completed. In exemplary embodiments, the shifts 782 associated with the tasks 732 can be changed in the graphical user interface 700. For example, the graphical user interface 700 can include data entry fields 784, e.g., drop-down lists, that can be selected by a user to change in the shifts 782 associated with the tasks. By allowing the user to adjust the shifts 782 associated with the tasks 732, exemplary embodiments of the present disclosure advantageously allow a user to move tasks from one shift to another shift to adjust for workforce resource availability. For example, the user wish to assign the tasks 732 to the overnight shift, but the workforce scheduled to work during the night may be overwhelmed by amount of time required to complete the tasks 732 (e.g., the amount of time required to complete the tasks exceeds the total man-hours available to complete the tasks). To adjust for this, the user can move one or more tasks 732 to the daytime shift.

In response to a selection of a button 790, the processor can programmatically verify whether the workload has be prioritized in a manner that completion of the plan is feasible. If the plan is feasible, the plan can be programmatically finalized and the workload estimate 126 can be provided to the user, labels can be automatically printed for the freight, which include information specified for the freight in, for example, the graphical user interface 600 shown in FIG. 6 (e.g., product information, quantity information, notes/instructions, department information), and/or tasks 732 can be initiated within an associate task management system based on, for example, the list 710 of tasks 732 shown in FIG. 7 (e.g., binning tasks, side counter tasks, feature tasks). The tasks 732 can be automatically initiated in the associate task management system to programmatically assign employees the tasks 732 and/or can create a workflow for completing the tasks 732. If the plan is not feasible, the user can be instructed to reprioritize one or more tasks (e.g., by changing the shift associated with the tasks) and the plan can be re-verified. If all tasks that are moveable from one shift to another have been moved, but the plan is still not feasible, the processor can finalize the plan despite the recognized deficiencies in the plan.

FIG. 8 depicts a flow diagram of an exemplary computer-implemented process 800 for finalizing an unload action plan in which tasks associated with freight to be unloaded can be prioritized and a feasibility of an unload action plan can be programmatically verified (e.g., verification of a workload estimate) before approval of the unload action plan is granted. The process 800 starts at step 802. At step 804, freight data representing freight items is accessed by a processor programmed to execute code to implement process 800. The freight items may represent, for example, individual items, such as items 102a, 102b, 102c, 102d in FIG. 1, boxes of items, and/or pallets of items scheduled to be shipped to a receiving site (e.g., the retail store 120 of FIG. 1). The freight data can include a plurality of processing codes. Each processing code can correspond to one or more of the items 102a, 102b, 102c, 120d included in the freight. At step 806, the freight to be received can be represented graphically in a graphical user interface rendered on a display. The freight can be grouped by a type, such as pallet pulls, star freight, and large cube basic items, and within each group, the freight items can be separated graphically into blocks based on the content of the freight.

At step 808, one or more tasks can be associated with the blocks of freight and at step 810, a transportation mechanism can be associated with the freight. The one or more tasks can include, for example, whether the freight will be unloaded to a bin, a side counter, or a feature location in the store. The transportation mechanism can include, for example, a pallet truck, an L-cart, or a rocket-cart. In some embodiments, the tasks and/or transportation mechanism can be programmatically associated with the blocks of freight by the processor. In some embodiments, a user can interact with the user interface to select the tasks and transportation mechanisms to be associated with the freight and the process can update the association in response to the user input.

At step 812, the processor can be programmed to execute code to specify an estimated amount of time that a task associated with a block of freight will take to complete for the freight associated with a block and can be display the estimated amount of time to the user via the graphical user interface. The estimated amount of time can be based on historical or other data and can be dependent on the task(s) associated with the block of freight. For example, stocking a feature item can historically take more time then stocking a side counter item. If the user changes the selected task to another task, the processor can be programmed to update the estimated amount of time to reflect the newly selected task. After tasks and transportation mechanisms are selected for the blocks of freight, the user can interact with the user interface to initiate a prioritization of the tasks associated with the freight at step 814.

At step 816, the processor can be programmed to execute code to render a prioritization user interface on a display to allow a user to view and/or adjust a prioritization of tasks that have been associated with the freight. At step 818, the user can interact with the prioritization interface to adjust the priority of tasks and/or change the work shift (e.g., overnight, daytime) associated with the tasks. At step 820, the processor can verify the unload action plan and prioritizations of the tasks associated with the freight and can determine whether to approve or reject the plan. If the plan is approved (step 822), at step 824, the processor is programmed to execute code to generate a plan that includes the workload estimate, print labels to be affixed to the freight upon receipt that include information specified for the freight in, for example, the graphical user interface 600 shown in FIG. 6 (e.g., product information, quantity information, notes/instructions, department information), and/or initiate tasks within an associate task management system based on, for example, the list 710 of tasks 732 shown in FIG. 7 (e.g., binning tasks, side counter tasks, feature tasks). Otherwise, the processor is programmed to execute code to indicate to the user that the plan has been rejected at step 826. The process ends at step 828.

FIG. 9 depicts a flow diagram of an exemplary computer-implemented process 900 for verifying an unload action plan and/or a workload estimate (e.g., steps 820-826 of FIG. 8). The process begins at step 902. At step 904, the processor is programmed to execute code to check that the plan is feasible based on the remaining available hours for both the scheduled sales floor workforce and the scheduled backroom workforce. At step 906, the processor can execute code to verify a plan and workload estimate by verification by determining whether (A) data fields including the available hours for the scheduled sales floor workforce and the scheduled backroom workforce are a positive number; (B) either field is negative, but the sum of the two fields is greater than or equal to zero; or (C) sum of both fields is negative.

If the processor determines that the data fields for the available hours for the scheduled sales floor workforce and the scheduled backroom workforce are a positive number (e.g., the total estimate workload for the sales floor is less than the total sales floor workforce hours scheduled and the total estimate workload for the back room workforces is less than the total back room workforce hours scheduled) (case A), the processor is programmed to finalize the plan at step 908 because the division of labor and the workforce available is suitable for completing the plan. As described herein, finalization of the plan can include generate a plan that includes the workload estimate, printing labels that include information specified for the freight, and/or initiate tasks within an associate task management system.

If the processor determines that either of the data fields for the available hours for the scheduled sales floor workforce and the scheduled backroom workforce is negative, but the sum of the two data fields is greater than or equal to zero (case B), the processor renders a pop up window on the display to warn the user that one of the fields is negative at step 910. At step 912, the user can determine whether to ignore the warning and finalize the plan or to reprioritize the tasks (e.g., by moving some tasks from the overnight shift to the day-time shift) and re-run the verification of the plan. The user can finalize the plan under these circumstances because the hours assigned to the scheduled workforce at the store are sufficient to complete the plan, but may require moving associate between the sales floor and backroom.

If the sum of both data fields is negative (case C), the processor can prompt the user to move tasks to the daytime shift until the sum of the two fields is greater than or equal to zero at step 914. In exemplary embodiments, the processor can be programmed to recognize that workload driven stocking tasks are a priority and can, via the user interface, request that that some or all of the tasks be moved to the daytime shift based on their priority. In some embodiments, binning (both basic and feature) can be considered “custom tasks” and the processor can be programmed to require that these tasks be moved to the daytime shift in order to finalize the plan. At step 916, the tasks can be reprioritized between shifts and the verification of the plan can be rerun. In some embodiments, in the event that the store has moved all custom tasks to the daytime shift and the sum for both fields is still negative, the processor can be programmed to allow the plan to finalize at step 918 despite the recognized deficiencies in available hours. This can advantageously allow a plan to be finalized even though it has be determined that it may not be feasible to complete the plan as specified. The process ends at step 920.

FIG. 10 is a block diagram of a freight processing system configured in an exemplary computing device 1000 that may be used to implement exemplary embodiments described herein. In some embodiments, the computing device 1000 is included in a retail point of sale terminal, servers, back office system and/or other computing resource. The computing device 1000 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 1006 included in the computing device 1000 may store non-transitory computer-readable and computer-executable instructions, code, or software for implementing exemplary embodiments, such as process 400 for automatically generating report data. The computing device 1000 also includes configurable and/or programmable processor 1002 and associated core 1004, and optionally, one or more additional configurable and/or programmable processor(s) 1002a and associated core(s) 1004a (for example, in the case of computer systems having multiple processors/cores), for executing non-transitory computer-readable and computer-executable instructions or software stored in the memory 1006 and other programs for controlling system hardware. Processor 1002 and processor(s) 1002a may each be a single core processor or multiple core (1004 and 1004a) processor.

Virtualization may be employed in the computing device 1000 so that infrastructure and resources in the computing device may be shared dynamically. A virtual machine 1014 may be provided to handle a process running on multiple processors so that the process appears to be using only one computing resource rather than multiple computing resources. Multiple virtual machines may also be used with one processor.

Memory 1006 may include a computer system memory or random access memory, such as DRAM, SRAM, EDO RAM, and the like. Memory 1006 may include other types of memory as well, or combinations thereof. Memory 1006 may be used to store information such as manifest data 142, business rules 132, report data 134 and/or any other information.

A user may interact with the computing device 1000 through a visual display device 1018, such as a computer monitor or touch screen display integrated into the computing device 1000, which may display one or more user interfaces 1020 (e.g., the user interface 300 of FIG. 3 displaying the workload estimate 126 of FIG. 1) that may be provided in accordance with exemplary embodiments. The computing device 1000 may include other I/O devices for receiving input from a user, for example, a keyboard or any suitable multi-point touch interface 1008, a pointing device 1010 (e.g., a mouse). The keyboard 1008 and the pointing device 1010 may be coupled to the visual display device 1018. The computing device 1000 may include other suitable conventional I/O peripherals.

The computing device 1000 may also include one or more storage devices 1024, such as a hard-drive, CD-ROM, or other non-transitory computer-readable media, for storing data and non-transitory computer-readable instructions and/or software that implement exemplary embodiments described herein. The storage devices 1024 may be integrated with the computing device 1000. The computing device 1000 may communicate with the one or more storage devices 1024 via a bus 1035. The bus 1035 may include parallel and/or bit serial connections, and may be wired in either a multi-drop (electrical parallel) or daisy-chain topology, or connected by switched hubs, as in the case of USB. Exemplary storage device 1024 may also store one or more databases 1026 for storing any suitable information required to implement exemplary embodiments. For example, exemplary storage device 1024 can store one or more databases 1026, for storing information, such as manifest data 142, business rules 132, report data 134 and/or any other information. The storage device 1024 can also store an engine 1030 including logic and programming for generating the report data, including the workload estimate, general merchandise unload action plan and/or grocery unload action plan, and for performing one or more of the exemplary methods disclosed herein.

The computing device 1000 can include a network interface 1012 configured to interface via one or more network devices 1022 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 1012 may include a built-in network adapter, network interface card, PCMCIA network card, card bus network adapter, wireless network adapter, USB network adapter, modem or any other device suitable for interfacing the computing device 1000 to any type of network capable of communication and performing the operations described herein. Moreover, the computing device 1000 may be any computer system, such as a point of sale terminal (employee-assisted register and/or customer self-service kiosk), workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 1000 may run any operating system 1016, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 1016 may be run in native mode or emulated mode. In an exemplary embodiment, the operating system 1016 may be run on one or more cloud machine instances.

FIG. 11 is a block diagram of an exemplary network environment 1100 suitable for a distributed implementation of exemplary embodiments of a freight processing system, methods and non-transitory computer-readable media. The network environment 1100 may include one or more servers 1102 and 1104, one or more clients 1106 and 1108, and one or more databases 1110 and 1112, each of which can be communicatively coupled via a communication network 1114, such as the network 120 of FIG. 1. The servers 1102 and 1104 may take the form of or include one or more computing devices 1000a and 1000b, respectively, that are similar to the computing device 1000 illustrated in FIG. 10. The clients 1106 and 1108 may take the form of or include one or more computing devices 1000c and 1000d, respectively, that are similar to the computing device 1000 illustrated in FIG. 10. For example, clients 1106 and 1108 may include mobile user devices. Similarly, the databases 1110 and 1112 may take the form of or include one or more computing devices 1000e and 1000f, respectively, that are similar to the computing device 1000 illustrated in FIG. 10. While databases 1110 and 1112 have been illustrated as devices that are separate from the servers 1102 and 1104, those skilled in the art will recognize that the databases 1110 and/or 1112 may be integrated with the servers 1102 and/or 1104 and/or the clients 1106 and 1108.

The network interface 1012 and the network device 1022 of the computing device 1000 (as shown in FIG. 10) enable the servers 1102 and 1104 to communicate with the clients 1106 and 1108 via the communication network 1114. The communication network 1114 may include, but is not limited to, the Internet, an intranet, a LAN (Local Area Network), a WAN (Wide Area Network), a MAN (Metropolitan Area Network), a wireless network, an optical network, and the like. The communication facilities provided by the communication network 1114 are capable of supporting distributed implementations of exemplary embodiments.

In exemplary embodiments, one or more client-side applications 1107 may be installed on client 1106 and/or 1108 to allow users of clients 1106 and/or 1108 to access and interact with a multi-user service 1032 installed on the servers 1102 and/or 1104. For example, the users of clients 1106 and/or 1108 may include users associated with an authorized user group that are authorized to access and interact with the multi-user service 1032. In some embodiments, the servers 1102 and 1104 may provide client 1106 and/or 1108 with the client-side applications 1107 under a particular condition, such as a license or use agreement. In some embodiments, clients 1106 and/or 1108 may obtain the client-side applications 1107 independent of the servers 1102 and 1104. The client-side application 1107 can be computer-readable and/or computer-executable components or products, such as computer-readable and/or computer-executable components or products for presenting a user interface for the multi-user service. One example of a client-side application is a web browser configured to display a web page containing the report data 134 and/or the workload estimate 126, the web page being hosted by the servers 1102 and/or the server 1104, which may provide access to the multi-user service. Another example of a client-side application is a mobile application (e.g., a smart phone or tablet application) that can be installed on client 1106 and/or 1108 and can be configured and/or programmed to access a multi-user service implemented by the servers 1102 and/or 1104. The servers 1102 and 1104 can also provide one or more engines 1034, 1036 including logic and programming for receiving the manifest data 142 and/or the business rules 132 and generating the report data 134 based on the manifest data 142 and business rules 132, for performing one or more of the exemplary methods disclosed herein.

The databases 1110 and 1112 can store user information, manifest data 142, report data 132 and/or any other information suitable for use by the multi-user service 1032. The servers 1102 and 1104 can be programmed to generate queries for the databases 1110 and 1112 and to receive responses to the queries, which may include information stored by the databases 1110 and 1112.

Having thus described several exemplary embodiments of the disclosure, it is to be appreciated various alterations, modifications, and improvements will readily occur to those skilled in the art. Accordingly, the foregoing description and drawings are by way of example only.

1-22. (canceled)

23. A method comprising:
receiving, via one or more graphical user interface, input for electronically associating tasks with freight items to be received by a store via a graphical user interface;
programmatically generating an estimated amount of time required to complete each of the tasks;
executing code to generate an allocation of the tasks to a first group of a workforce and to a second group of the workforce to form an unload plan in response to the estimated amount of time required to complete each of the tasks;
rendering the allocation of tasks via the one or more graphical user interfaces to display the allocation to a user;
receiving, via the one or more graphical user interfaces, a reallocation of the tasks between the first group and the second group in response to input from the user to alter the unload plan; and
executing code to determine whether the unload plan is feasible based on the reallocation of the tasks between the first and second groups and to present a determination of feasibility of the unload plan to the user via the one or more graphical user interfaces.

24. The method of claim 23, further comprising:
determining a first estimated cumulative amount of time required for the first group to complete the tasks associated with the first group.

25. The method of claim 24, wherein executing code to determine whether the unload plan is feasible comprises:
comparing the first estimated cumulative amount of time to a total number of man-hours scheduled for the first group; and
determining whether the unload plan is feasible in response to the comparison.

26. The method of claim 23, further comprising:
determining a first estimated cumulative amount of time required for the first group to complete the tasks associated with the first group; and
determining a second estimated cumulative amount of time required for the second group to complete the tasks associated with the second group.

27. The method of claim 26, wherein executing code to determine whether the unload plan is feasible comprises:
comparing the first estimated cumulative amount of time to a first total number of man-hours scheduled for the first group;
comparing the second estimated cumulative amount of time to a second total man-hours scheduled for the second group; and
determining whether the unload plan is feasible in response to the comparisons.

28. The method of claim 23, wherein the first group represents a scheduled overnight workforce and the second group represents a scheduled day workforce.

29. The method of claim 28, wherein executing code to determine whether the unload plan is feasible comprises:
executing code to determine whether a first total number of man-hours corresponding to the scheduled overnight workforce is equal to or greater than a first estimated cumulative amount of time required for the scheduled overnight workforce to complete the tasks associated with the scheduled overnight workforce; and
executing code to determine whether a second total number of man-hours corresponding to the scheduled day workforce is equal to or greater than a second estimated cumulative amount of time required for the scheduled day workforce to complete the tasks associated with the scheduled day workforce.

30. The method of claim 29, wherein executing code to determine whether the unload plan is feasible further comprises:
executing code to determine whether the unload plan is feasible in response to determining that the first total number of man-hours is equal to or greater than the first estimated cumulative amount of time and determining that the second total number of man-hours is equal to or greater than the second estimated cumulative amount of time.

31. The method of claim 29, wherein it is determined that the first total number of man-hours is less than the first estimated cumulative amount of time or the second total number of man-hours is less than the second estimated cumulative amount of time, and wherein executing code to determine whether the unload plan is feasible further comprises:
executing code to determine whether a man-hour sum of the first total number of man-hours and the second total number of man-hours exceeds a workload sum of the first estimated cumulative amount of time and the second estimated cumulative time; and
requesting a re-allocation of the tasks in response to the man-hour sum being greater than the workload sum.

32. The method of claim 29, wherein it is determined that the first total number of man-hours is less than the first estimated cumulative amount of time or the second number of man-hours is less than the second estimated cumulative amount of time, and wherein executing code to determine whether the unload plan is feasible further comprises:
executing code to determine whether a man-hour sum of the first total number of man-hours and the second total number of man-hours is less than a workload sum of the first estimated cumulative amount of time and the second estimated cumulative time; and
executing code to determine that the unload plan is not feasible when the man-hour sum is less than the workload sum.

33. A system comprising:
a non-transitory computer-readable medium storing instructions for generating an unload plan for a delivery of freight;
a processing device programmed to execute the instructions to:
render one or more graphical user interfaces on a display of the system;
receive input from a user of the system via the one or more graphical user interfaces to associate tasks with freight items to be received by a store via a graphical user interface;
generate an estimated amount of time required to complete each of the tasks;
generate an allocation of the tasks to a first group of a workforce and to a second group of the workforce to form an unload plan in response to the estimated amount of time required to complete each of the tasks;
render the allocation of tasks via the one or more graphical user interfaces to display the allocation to the user;
receive, via the one or more graphical user interfaces, a reallocation of the tasks between the first group and the second group in response to input from the user to alter the unload plan;
determine whether the unload plan is feasible based on the reallocation of the tasks between the first and second groups; and
present a determination of feasibility of the unload plan to the user via the one or more graphical user interfaces.

34. The system of claim 33, wherein the first group represents a scheduled overnight workforce and the second group represents a scheduled day workforce.

35. The system of claim 34, wherein the processing device is programmed to execute the instructions to determine whether the unload plan is feasible by:
determining whether a first total number of man-hours corresponding to the scheduled overnight workforce is equal to or greater than a first estimated cumulative amount of time required for the scheduled overnight workforce to complete the tasks associated with the scheduled overnight workforce; and
determining whether a second total number of man-hours corresponding to the scheduled day workforce is equal to or greater than a second estimated cumulative amount of time required for the scheduled day workforce to complete the tasks associated with the scheduled day workforce.

36. The system of claim 35, wherein the processing device is programmed to execute the instructions to determine whether the unload plan is feasible further by:
determining whether the unload plan is feasible in response to determining that the first total number of man-hours is equal to or greater than the first estimated cumulative amount of time and determining that the second total number of man-hours is equal to or greater than the second estimated cumulative amount of time.

37. The system of claim 35, wherein the processing device determines that the first total number of man-hours is less than the first estimated cumulative amount of time or the second total number of man-hours is less than the second estimated cumulative amount of time, and wherein the processing device is programmed to execute the instructions to determine whether the unload plan is feasible by:
determining whether a man-hour sum of the first total number of man-hours and the second total number of man-hours exceeds a workload sum of the first estimated cumulative amount of time and the second estimated cumulative time; and
requesting a re-allocation of the tasks in response to the man-hour sum being greater than the workload sum.

38. The system of claim 35, wherein the processing device determines that the first total number of man-hours is less than the first estimated cumulative amount of time or the second total number of man-hours is less than the second estimated cumulative amount of time, and wherein the processing device is programmed to execute instructions to determine whether the unload plan is feasible by:
determining whether a man-hour sum of the first total number of man-hours and the second total number of man-hours is less than a workload sum of the first estimated cumulative amount of time and the second estimated cumulative time; and
determining that the unload plan is not feasible when the man-hour sum is less than the workload sum.

39. A non-transitory computer-readable medium storing instruction, wherein execution of the instructions by a processing device cause the processing device to implement a process comprising:
receiving, via one or more graphical user interface, input for electronically associating tasks with freight items to be received by a store via a graphical user interface;
programmatically generating an estimated amount of time required to complete each of the tasks;
executing code to generate an allocation of the tasks to a first group of a workforce and to a second group of the workforce to form an unload plan in response to the estimated amount of time required to complete each of the tasks;
rendering the allocation of tasks via the one or more graphical user interfaces to display the allocation to a user;
receiving, via the one or more graphical user interfaces, a reallocation of the tasks between the first group and the second group in response to input from the user to alter the unload plan; and
executing code to determine whether the unload plan is feasible based on the reallocation of the tasks between the first and second groups and to present a determination of feasibility of the unload plan to the user via the one or more graphical user interfaces.

40. The medium of claim 39, wherein the first group represents a scheduled overnight workforce and the second group represents a scheduled day workforce.

41. The medium of claim 39, wherein execution of the instructions by the processing device causes the processing device to determine whether the unload plan is feasible by:
determining whether a first total number of man-hours corresponding to the scheduled overnight workforce is equal to or greater than a first estimated cumulative amount of time required for the scheduled overnight workforce to complete the tasks associated with the scheduled overnight workforce; and
determining whether a second total number of man-hours corresponding to the scheduled day workforce is equal to or greater than a second estimated cumulative amount of time required for the scheduled day workforce to complete the tasks associated with the scheduled day workforce.

42. The medium of claim 41, wherein execution of the instructions by the processing device causes the processing device to determine whether the unload plan is feasible further by:
determining whether the unload plan is feasible in response to determining that the first total number of man-hours is equal to or greater than the first estimated cumulative amount of time and determining that the second total number of man-hours is equal to or greater than the second estimated cumulative amount of time.
